(19) United States
(12) Patent Application Publication
(10) Pub. No.: US 2025/0265119 A1
(43) Pub. Date: Aug. 21, 2025

(54) PROCESSOR RESOURCE ISOLATION

(71) Applicant: Microsoft Technology Licensing, LLC, Redmond, WA (US)

(72) Inventors: Stavros VOLOS, Cambridge (GB); Cédric Alain Marie Christophe FOURNET, Cambridge (GB); Boris Alexander KOEPF, Cambridge (GB); Jana HOFMANN, Cambridge (GB); Oleksii OLEKSENKO, Cambridge (GB)

(73) Assignee: Microsoft Technology Licensing, LLC, Redmond, WA (US)

(21) Appl. No.: 18/444,947

(22) Filed: Feb. 19, 2024

(51) Int. Cl. G06F 9/50

(52) U.S. Cl. CPC G06F 9/5016

(57) ABSTRACT

A method for allocating resources of a processor is described. A coloring scheme is obtained for resources of the processor, where the coloring scheme has a coloring function that indexes both shared resources and private resources of the processor and provides protection against information leakage through the shared resources of the processor between the trust domains. A first set of colors is assigned, from a plurality of unassigned colors according to the coloring scheme, to a first trust domain. First resources are allocated to the first trust domain according to the first set of colors, where each of the first resources has an assigned color of the first set of colors.

### BACKGROUND

Cloud computing aims to provide scalable and cost-effective resources to a wide range of tenants. This involves sharing resources between tenants (e.g., trust domains), while isolating tenants from one another and from the cloud provider to ensure their security. For example, modern cloud processors may include hundreds of physical threads sharing terabytes of memory, all of which may be flexibly assigned to many independent trust domains (e.g., virtual machines, containers, etc.).

Cloud security generally relies upon architectural isolation between trust domains, enforced by the underlying hardware and, in the case of virtual machines, a hypervisor via access control and permissions. For example, certain resources may be private to a processor core (e.g., registers, L1 cache, L2 cache) and the processor core may be assigned exclusively to a single virtual machine. Accordingly, a virtual machine cannot read from or write to private registers within a different processor core or memory addresses assigned to a different virtual machine. Unfortunately, implicit sharing of other resources within a processor, such as caches, buffers, cache-coherence directories, and memory banks, may also allow for information leakage between different virtual machines or other trust domains. For example, information about a first virtual machine may be inferred (e.g., by a second virtual machine) by analyzing time delays associated with use of a shared resource, analyzing eviction sets for a shared cache, or via other side channel attacks.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to improved isolation between trust domains despite available side channels.

In one aspect, a method for allocating resources of a processor is provided. A coloring scheme is obtained for resources of the processor, where the coloring scheme has a coloring function that indexes both shared resources and private resources of the processor and provides protection against information leakage through the shared resources of the processor between the trust domains. A first set of colors is assigned, from a plurality of unassigned colors according to the coloring scheme, to a first trust domain. First resources are allocated to the first trust domain according to the first set of colors, where each of the first resources has an assigned color of the first set of colors.

In another aspect, a computing device for allocating processor resources of a processor is provided. The computing device comprises the processor and a non-transitory computer-readable memory, wherein the processor is configured to carry out instructions from the memory that configure the computing device to: identify a first linear function that indexes a first resource of the processor resources, wherein the first resource is a first shared resource of the processor; identify a second linear function that indexes a second resource of the processor resources; combine the first linear function and the second linear function to generate a coloring function that indexes the first shared resource and the second resource based on whether the second resource is a second shared resource or a private resource, wherein generating the coloring function maximizes available colors of a coloring scheme and avoids partitioning the private resource; assign a first set of colors, from a plurality of unassigned colors according to the coloring scheme, to a first trust domain; and allocate at least some of the processor resources to the first trust domain according to the first set of colors using the coloring function, wherein each of the allocated resources has an assigned color of the first set of colors and provides protection against information leakage between the first trust domain and one or more second trust domains.

In yet another aspect, a method for allocating processor resources of a processor is provided. A first linear function that indexes a first resource of the processor resources is identified, where the first resource is a first shared resource of the processor. A second linear function that indexes a second resource of the processor resources is identified. The first linear function and the second linear function are combined to generate a coloring function that indexes the first shared resource and the second resource based on whether the second resource is a second shared resource or a private resource, where generating the coloring function maximizes available colors of a coloring scheme and avoids partitioning the private resource. A first set of colors is assigned, from a plurality of unassigned colors according to the coloring scheme, to a first trust domain. At least some of the processor resources are allocated to the first trust domain according to the first set of colors using the coloring function, where each of the allocated resources has an assigned color of the first set of colors and provides protection against information leakage between the first trust domain and one or more second trust domains.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example processor in which resources may be allocated to various trust domains, according to an aspect.

FIG. 2 shows a block diagram of an example system of hardware and software for resource allocation, according to an aspect.

FIG. 3 shows a diagram of example index functions for resources of a processor, according to an aspect.

FIG. 4 shows a diagram of an example memory allocation, according to an aspect.

FIG. 5 shows a flowchart of an example method of allocating resources of a processor, according to an example embodiment.

FIG. 6 shows a flowchart of another example method of allocating resources of a processor, according to an example embodiment.

FIG. 7 is a block diagram illustrating example physical components of a computing device with which aspects of the disclosure may be practiced.

FIG. 8 is a simplified block diagram of a computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various examples of performing resource allocation for processors in a manner that improves isolation between trust domains by preventing information leakage via side channel attacks. A processor may be configured with or may otherwise have various private resources (“private resources”) and shared resources (“shared resources”). Both resources may be higher level resources such as memory or processor cores, or may be microarchitectural resources such as chiplet directories and caches. Although private resources may be exclusive to a processor core and thus provide some level of isolation, as data is stored and managed by the shared resources (e.g., system memory through different levels of cache) to reach the processor core, information about operations of the processor core may still be inferred using information about the shared resource, thereby potentially still succumbing to any of a variety of side channel attacks. To improve isolation among different trust domains, a coloring scheme is utilized to provide further separation of data and reduced information leakage. Instead of allocating free memory pages that may share the same cache lines, the coloring scheme described herein is (alternatively or additionally) used to ensure that allocated memory pages for a trust domain are isolated from other trust domains, even as the data in the allocated memory pages is transferred through a memory subsystem (e.g., from system memory to L3 cache, L2 cache, etc.).

The coloring scheme may be applied to both shared and private resources (e.g., of a processor) and configured to promote flexibility in resource allocation, while reducing or avoiding performance penalties that are typically caused by subdivision of resources (e.g., subdivision of private resources that would not be shared). A coloring scheme is obtained for resources of the processor. The coloring scheme has a coloring function that indexes both shared resources and private resources of the processor and provides protection against information leakage through the shared resources of the processor between the trust domains. A first set of colors is assigned, from a plurality of unassigned colors according to the coloring scheme, to a first trust domain. First resources are allocated to the first trust domain according to the first set of colors, where each of the first resources has an assigned color of the first set of colors. Improved isolation from information leakage is provided by enforcing the use and allocation of resources that are only associated with a particular color for the first trust domain. Thus, as resources are allocated for a second trust domain (e.g., according to a second set of memory colors), privacy between trust domains is improved as a result of adhering to the sets of colors that correspond to each of the trust domains.

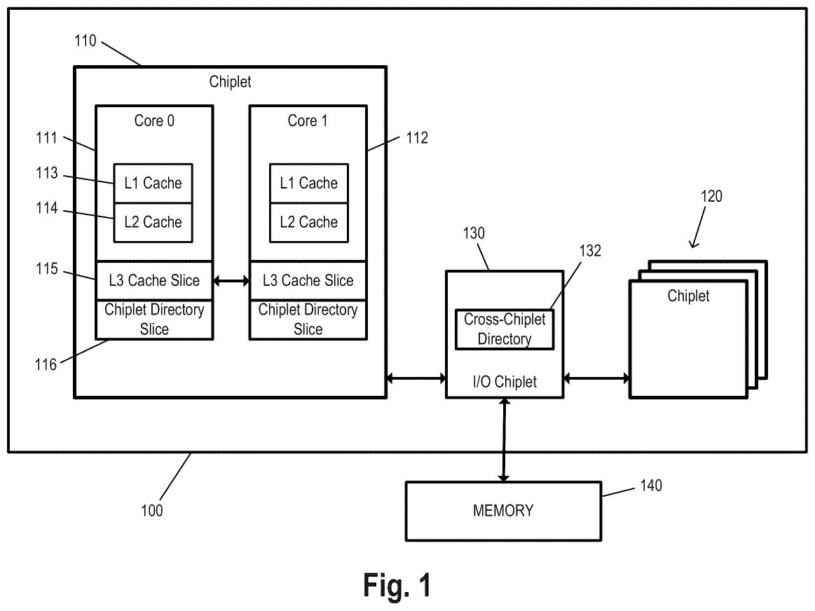

This and many further aspects for a computing device are described herein. For instance, FIG. 1 shows a block diagram of an example processor 100 in which resources may be allocated to various trust domains, according to an aspect. The processor 100 is a multicore processor having a plurality of microarchitectural resources arranged in a plurality of chiplets, for example, a chiplet 110 and one or more other chiplets 120. In the example shown in FIG. 1, the chiplets 110 and 120 generally have a same architecture, so only the chiplet 110 is described in detail. In other examples, the processor 100 may have two or more different chiplet architectures for more versatile resource allocations, such as a high power processing chiplet (e.g., running at 6 GHz) for complex processing tasks and a low power processing chiplet (e.g., running at 2 GHz with reduced voltage) for simple processing tasks and reduced power consumption. As another example, the processor 100 may be of a monolithic design and may therefore not have a number of chiplets and/or may have a different architecture. It will therefore be appreciated that, while examples are described in the context of a number of chiplets and a corresponding architecture, similar aspects may be used to allocate computing resources for any of a variety of computing hardware.

Generally, the chiplet 110 comprises private microarchitectural resources (“private resources”) and shared microarchitectural resources (“shared resources”). Private resources may differ among processor implementations, but generally include processor cores, registers that are exclusive to a particular processor core, cache that is exclusive to a particular processor core (e.g., L1 data cache, L1 instruction cache, L2 cache), etc. Shared resources may also differ among processor implementations, but generally include shared caches (e.g., L3 cache shared by two or more cores or chiplets), cache coherence directories, system memory or memory channels (e.g., for dynamic random access memory), etc. In the example shown in FIG. 1, the chiplet 110 comprises a plurality of cores, including core 111 (core 0) and core 112 (core 1). Each of the cores 111 and 112 includes an L1 cache and an L2 cache (e.g., L1 cache 113 and L2 cache 114). In other examples, different cores within a chiplet may have different amounts or hierarchies of cache.

In the example shown in FIG. 1, the chiplet 110 has an L3 cache slice 115 associated with the core 111 and a similar L3 cache slice associated with the core 112. The L3 caches are shareable among cores within the chiplet 110. Although the example shown in FIG. 1 includes one L3 cache slice per core, the number of cache slices may be less than or greater than the number of cores within the processor 100 (e.g., where some cores are configured with lower processing power and power consumption than other cores). The chiplet 110 further comprises a chiplet directory configured to manage data within private caches, such as the L2 cache 114. In the example shown in FIG. 1, the chiplet directory is arranged in chiplet directory slices, such as chiplet directory slice 116, distributed across cores of the processor 100, but other implementations will be apparent to those skilled in the art. The chiplet directory slice 116 is a cache coherence directory that supports sharing of data among different cores within the chiplet 110. Generally, the chiplet directory slice 116 tracks which blocks of memory are cached within the private cache (e.g., the L2 cache) of each core.

The processor 100 further comprises an I/O chiplet 130 that supports communication to and from the chiplets 110 and 120. The I/O chiplet 130 may also support communication between the processor 100 and a memory 140, such as a dynamic random access memory (DRAM) memory bank. In some examples, the I/O chiplet 130 comprises a cross-chiplet directory 132 as a cache coherence directory. Similarly to the chiplet directory slice 116, the cross-chiplet directory 132 is configured to manage data within shareable caches, but instead supports sharing of data among different chiplets (i.e., chiplets 110 and 120) within the processor 100.

Access to data at a memory memory address by a core (e.g., core 111) may be performed as follows. First, the LI cache 113 is accessed to determine whether the data is stored therein. While accessing the L1 cache, the core 111 may also identify locations within the L2 cache 114 that may contain the data (e.g., by performing a virtual to physical address mapping). When the data is not found in the LI cache 113, the core 111 accesses the identified locations within the L2 cache 114. L1 misses that also miss in the L2 cache are served by the L3 cache slice 115. After an L3 cache miss against the L3 cache slice 115, the core 111 probes the chiplet directory slice 116. Probe hits on the chiplet directory slice 116 are forwarded to the core that owns a cache line within its L1 or L2 cache having the data, whereas probe misses are forwarded as requests to the I/O chiplet 130. These requests probe the cross-chiplet directory 132, where probe hits are forwarded to a chiplet owner (e.g., one of the chiplets 120), whereas probe misses are served by the memory 140 (e.g., via a DRAM controller, not shown). After the memory 140, data may be obtained from a disk (not shown) via the I/O chiplet 130, such as a solid state disk (SSD), hard disk drive (HDD), or other suitable processor-readable media. Other examples of the processor 100 may have different memory request lifecycles, according to their own architecture, as will be appreciated by those skilled in the art.

Generally, the memory request lifecycle over several levels of hierarchy (L1 cache, L2 cache, L3 cache, chiplet directories, memory) may affect latency to resources observed by a processor core, enabling a first trust domain (e.g., a virtual machine or a container) that shares resources with a second trust domain to use timing to predict or otherwise infer information from a shared resource from which a request is served. Changes in these timings may allow for memory-based side-channel attacks, in some examples. To improve isolation among different trust domains and reduce the likelihood of a memory-based side channel attack, the processor 100 is configured to use a coloring scheme to provide further separation of data and reduced information leakage. The coloring scheme may be applied to both shared and private resources (e.g., based on resources requests from trust domains) and configured to promote flexibility in resource allocation, while reducing or avoiding performance penalties caused by subdivision of resources. Generally, the coloring scheme provides a coloring function that indexes both the shared resources and the private resources and provides isolation between the colors. The coloring function divides the shared resources to maximize available colors of the coloring scheme and minimize subdivisions of the private resources.

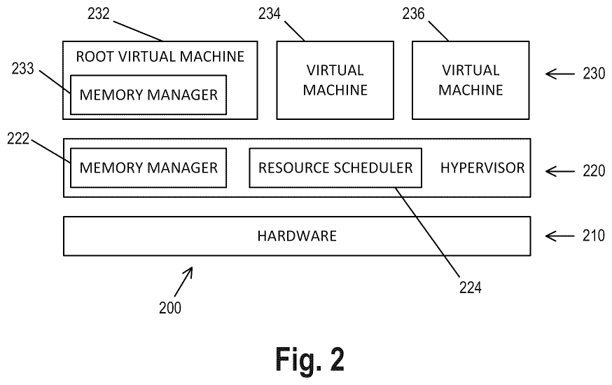

FIG. 2 shows a block diagram of an example system 200 of hardware and software for resource allocation, according to an aspect. Generally, the system 200 includes a hardware layer 210, a hypervisor 220 configured to manage trust domains, and one or more trust domains 230. The hardware layer 210 generally corresponds to the processor 100 or other suitable computing systems that may support trust domains. The hypervisor 220 is software that is configured to manage multiple trust domains on a single physical machine (i.e., hardware 210). In the examples described herein, the trust domains are virtual machines, but may be containers or other software execution environments in other examples.

The hypervisor 220 allocates physical resources, such as processor cores and memory (and in some examples, an L3 cache partition) of the processor 100, to individual virtual machines. As a result of resource allocation, an individual virtual machine may be implicitly allocated a portion of other microarchitectural resources. Generally, the hypervisor 220 comprises a memory manager 222 and a resource scheduler 224. The hypervisor 220 may also create or instantiate the trust domains 230, shut down trust domains, and/or release resources from trust domains. In the example shown in FIG. 2, the hypervisor 220 creates a root virtual machine 232, along with additional virtual machines 234, 236, and 238 as guest virtual machines. The root virtual machine 232 may correspond to a host operating system for the hardware 210, which may allow a user to view a current status of the hardware 210 and general information about the client virtual machines.

The memory manager 222 implements the coloring scheme for memory as described herein and is configured to allocate memory for the virtual machines, for example, from the memory 140. As data corresponding to a memory address is routed through the levels of memory hierarchy within the processor 100, the data may be mapped from particular locations within one level of the memory hierarchy to a next level according to an indexing function. To improve memory isolation, a coloring function is generated based on the indexing functions for the memory hierarchy. According to aspects described herein, the coloring function divides shared microarchitectural resources to maximize or otherwise increase available colors of the coloring scheme and minimize or otherwise decrease subdivisions of private microarchitectural resources, thereby ensuring that isolation is maintained for trust domains of different colors.

Although the memory manager 222 is shown in FIG. 2 and described herein as an element within the hypervisor 220, other implementations of the memory manager 222 may be used, in other examples. In some examples, aspects of the memory manager 222 are performed by a different memory manager 233 within the root virtual machine 232 (i.e., instead of the memory manager 222). In other examples, the memory manager 222 of the hypervisor 220 and the memory manager 233 of the root virtual machine 232 cooperate to provide the features described herein with respect to the memory manager 222. In one such example, the memory manager 233 allocates memory, but requests the hypervisor 220 to map the allocated memory to the address space of a trust domain (e.g., virtual machine 234). The memory manager 233 selects a color based on the coloring scheme and then selects memory addresses within the selected color. The memory manager 222 ensures that the color of one trust domain is not used by another trust domain.

The resource scheduler 224 is configured to allocate cores, chiplets, and/or other resources of the processor 100 (or time/cycles on those resources) to the virtual machines. In some examples, the resource scheduler 224 divides the cores or chiplets within a processor into processor groups and then exclusively assigns a group to a particular trust domain to improve isolation. For example, the resource scheduler 224 may group cores that share L3 cache (e.g., core 111 and core 112), cores within a chiplet, or chiplets within a processor. In some examples, the resources scheduler 224 exclusively assigns a processor group to a virtual machine for the lifetime of the virtual machine.

The memory manager 222 and the resource scheduler 224, in combination, improve isolation from side channel attacks by enforcing isolation contracts for the shared and private microarchitectural resources within the processor 100. Generally, the resources may be divided into compute resources, represented as hardware threads T={t₀, . . . , tₙ₋₁}, and memory resources, represented as physical addresses M={0, . . . , 2^{m}₋₁}. To define and determine the isolation contracts, mathematical partitions are used to model exclusive allocation and associated constraints.

A partition P of a set S is a collection of disjoint not-empty subsets of S whose union covers S, that is, P=(Cᵢ)_{i∈I} with Cᵢ ∩C₁ⱼ=∅ for all i≠j and U_{i∈I} Cᵢ=S. Each subset Cᵢ of the partition may be referred to as a class, or a color. The partitions of a given set can be partially ordered as follows: P is finer than Q, written P⊏ Q, when each class of P is included in a class of Q, or (equivalently) two elements in the same class of P are also in the same class of Q. Accordingly, the finest partition of S has a singleton class for each element of S, whereas the coarsest partition has just one class S that contains all elements. Partitions may be defined as pre-images of functions f from S to some index set, with a class Cᵢ=f ⁻¹(i) for each i∈image(f), that is, x∈Cᵢ if and only if f (x)=i.

For partitioning the compute resources, architectural primitives may be abstracted in terms of hardware threads T. For an example processor: Physical cores (e.g., cores 111 and 112) may be represented by grouping pairs of threads P_{Core}={{t₀, t₁}, {t₂, t₃}. . . }where each core supports two threads. This partition captures sharing of L1/L2 caches, translation lookaside buffers (TLBs), buffers, and predictors;

Chiplets having four cores each may be represented by the partition P_{Chiplet}={{t₀, . . . t₇}, {t₈, . . . , t₁₅}, . . . }, which also captures sharing of L3 caches and chiplet directories; and

Full 32-core processors may be represented by Pcpu={{t₀, . . . , t₆₃}}, which additionally captures sharing of the I/O chiplet and its cross-chiplet directory.

For a given partition P of T, a microarchitectural resource is considered private when its implementation is local to each class of P, and that it is shared otherwise. Hence, the L3 cache is private for chiplet partitions but shared for core partitions.

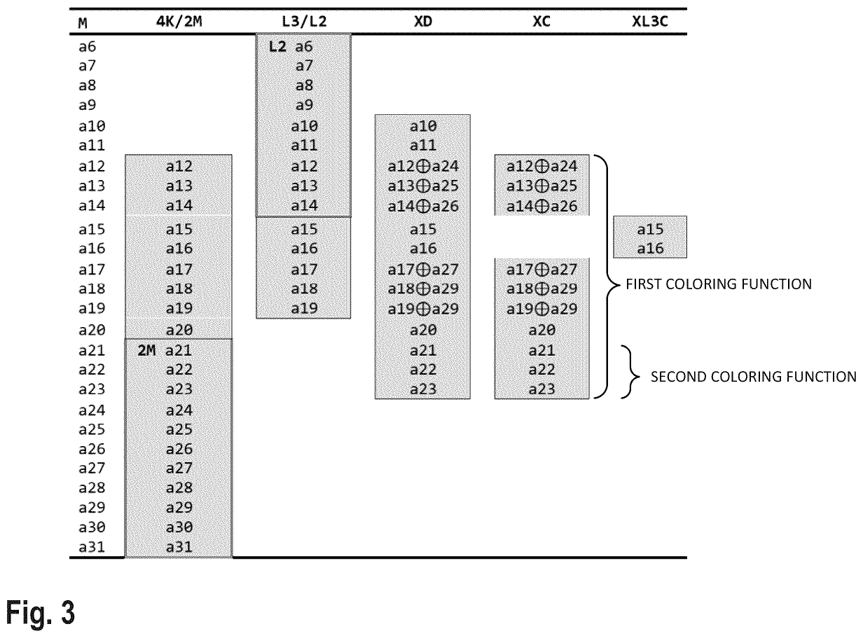

Physical memory partitions may be defined as the pre-images of linear functions, that is, functions from physical addresses M to bit vectors, with each bit defined as the XOR of some of the bits of the address. These functions are linear maps in the mathematical sense when physical addresses M are interpreted as a vector space F₂ⁿ over the binary field F₂, with bitwise XOR (⊕) and AND (&) for addition and multiplication. FIG. 3 shows example indexing functions for architectural pages (4K/2M), cache sets (L2/L3) and coherence directories (XD). Accordingly, the linear function f (a)=a >>12 maps a memory address to its 4K page, indexed by its most significant bits, and defines the partition P4K of physical memory into contiguous 4K pages, which reflects the usual architectural unit of memory protection. Similarly, g(a)=a >>21 maps addresses to huge page frame numbers, and defines the partition P_{2M} of huge pages (with P_{4K} ⊏P_{2M}).

The allocation of resources by the system software to different trust domains (indexed by D) may be represented as a partition P_{D}=(C_{d})_{d∈D} of the set of all resources T∪M. For each trust domain d ∈D, the class C_{d} indicates all threads and memory addresses allocated to d. A partition P_{D} of resources between trust domains may be considered to be isolating when the use of these resources by a trust domain cannot be observed from any other trust domain. Since threads and memory are usually allocated separately, their allocation constraints may be described using partitions P_{T} and P_{M} of T and M, respectively, and write P_{T} ∪P_{M} for the resulting partition of all resources in T∪M to be enforced by the memory manager 222 and resource scheduler 224 at run-time. The partition refinement relation (⊏) expresses system invariants as resources get reassigned over time, causing P_{D} to change. For example, P_{Core} ∪P_{4K} ⊏ P_{D} states that compute resources are allocated at core granularity (i.e., never splitting cores between trust domains) and memory at 4K page granularity (i.e., never splitting pages between trust domains), whereas P_{Chiplet} ∪P_{2M} ⊏P_{D} states that compute resources are allocated at chiplet granularity and memory at huge page granularity.

Allocation constraints that provide microarchitectural isolation between trust domains may be referred to herein as contracts. A partition P_{T} ØP_{M} is a resource isolation contract if an allocation P_{D} into trust domains with P_{T} ØP_{M} ⊏P_{D} is isolating. Although a contract {T}Ø{M}requires that all resources be allocated to a unique trust domain is isolating, it would not be very useful. Instead, isolation contracts are desired that enable as much flexibility and performance as possible. Even with core partitioning or chiplet partitioning, this is in general insufficient by itself, because any remaining shared microarchitectural resources (such as cache sets and directory sets) may still yield observable side-channels and break isolation. These side-channels may be prevented using memory partitioning, also known as memory coloring using a coloring scheme.

A corresponding memory partition P_{M} provides the following constraints:

P_{M} complies with all architectural constraints, e.g. support page-based allocation: P_{4K} ⊏ P_{M}, and ideally P_{2M} ⊏ P_{M};

P_{M} partitions all shared microarchitectural resources necessary to achieve isolation; and P_{M} does not partition any private microarchitectural resources (e.g., L2 caches), which would degrade performance.

For creating isolating memory partitions, different resources may be partitioned simultaneously, such as pages and cache sets. However, simultaneous partitioning may be considered as a join of partitions. Given two partitions P and Q, their join P␣Q is the finest partition that is coarser than both P and Q. For example, suppose that P_{L3} partitions the L3 cache into different cache sets. The partition P_{L3}␣P_{4K} jointly captures this partition together with the 4K-page architectural constraint, and it is the finest to do so. Hence, it provides the largest number of colors to prevent L3 leakage while retaining flexibility for memory allocation by the memory manager 222. Formally, (P_{L3} ␣P_{4K})⊏P_{M} if and only if P_{L3} ⊏P_{M} and P_{4K} ⊏P_{M}. As can be seen from FIG. 3, both constraints may be achieved in practice using indexing functions h(a)=(aᵢ)_{i=12.20}. On the other hand, the partition P_{L3} ␣P_{2M} requires both that the L3 cache is partitioned and that huge pages be allocated, which may be too demanding because every huge page spans all L3 cache sets. Accordingly, P_{L3}U P_{2M}={M}, that is, partitioning M between multiple domains is undesirable.

An algorithm is provided that efficiently identifies the join of any two partitions P_{f} and P_{g} defined by linear indexing functions f and g, relying on two insights from linear algebra:
1. Partitions that are the preimages of linear functions f and g can be expressed using their kernels, i.e., the subspaces that f and g map to zero.
2. The join of these partitions can be expressed using the sum of the corresponding kernels.
   The algorithm computes bases of the kernels of f and g, then computes a linear function h that represents their sum, each by one application of Gaussian elimination, for example.

Partitioning of private resources may be undesirable, causing reduced performance. For example, assuming a chiplet allocation with a partition Pμ to eliminate a side channel caused by a shared microarchitectural resource p (e.g., the cross-chiplet directory 132), a color C∈Pμ may be assigned to a trust domain. However, the L3 cache is private to a chiplet, so a trust domain could be expected to fully utilize its cache sets. Accordingly, if the trust domain has a working set that just fits in the L3 cache but its color C spans only half of the L3 cache sets, its performance will be reduced. To limit performance degradation, each color C assigned to a trust domain should be large enough to span all its private resources, which may involve finding a coarser partition than Pp, with fewer colors than theoretically possible.

Two partitions P and Q of a set are orthogonal, written (P⊥Q), if for all colors C0,C1∈P and C2,C3∈Q we have |C0∩C2|=|C1∩C3|. In particular, partitions defined by linear functions that operate on disjoint bits of the address (e.g., P_{L3} and P_{2M}) are orthogonal. This may help explain why the index functions of caches usually depend on lower bits of the address, so that, for example, each allocated 2M page is split between all cache sets. More generally, given a private resource and a shared resource indexed by linear functions f and g, an algorithm performed by the memory manager 222 efficiently computes a coloring index function h that partitions the shared resource with as many colors as possible without affecting the private resource, that is, P_{g} ⊏ Pₕ and P_{f} ⊥Pₕ. An important insight for this algorithm is that functions represented by linearly independent constraints have orthogonal partitions. The algorithm, performed by the memory manager 222, generates h by iteratively selecting constraints from g that are independent of those fromf combined with those constraints already selected from prior iterations (i.e., existing constraints from the coloring function).

FIG. 3 shows a diagram of example index functions for resources of a processor, according to an aspect. Generally, a virtual machine may be assigned a virtual address space that represents a contiguous block of memory. Since the physical memory of the processor 100 may be shared among multiple virtual machines, the virtual address space is mapped to the physical memory by an indexing function. The indexing function may be a linear function that maps a virtual address to a physical address (e.g., in the memory 140) according to values of individual bits within the virtual address.

Address bits for a virtual address are shown in a first column (M) of FIG. 3. In a second column (4K/2M), an indexing function for memory pages (a shared resource) uses address bits a12 to a31 to provide 4K memory pages and uses address bits a21 to a31 to provide 2M memory pages. In other words, mapping a virtual address to a 4K memory page may be performed by selecting the subset of address bits a12 to a31. In a third column, an L2 cache (e.g., L2 cache 114) is indexed using address bits a6 to a14, while an L3 cache (e.g., L3 cache slices 115) is indexed using address bits a6 to a19. The L2 cache in this example is an 8-way 256 kilobyte cache and the L3 cache is a 16-way 16 megabyte cache, but other cache sizes and configurations may be used in other examples. A similar index function is shown for the cross-chiplet directory (XD) in a fourth column. Different coloring functions are shown in a fifth column (XC) and sixth column (XL3C), described below.

Using the index functions shown in FIG. 3, two example coloring functions of a set of coloring functions for a coloring scheme are now described for memory allocation when processor allocation is made at a chiplet granularity, Pₑₕipₗₑt (i.e., assigning the chiplet 110 to a first virtual machine, assigning a second chiplet 120 to a second virtual machine). XC in FIG. 3 defines a coloring partition Pxc computed by the memory manager 222 as the finest partition that is both coarser than the index function of the cross-directory chiplet (XD) and orthogonal to the index function of the L3 cache (L3/L2). As shown in FIG. 3, a first coloring function using a composition of XC with 4K pages results in 1024 colors (i.e., using the 10 bit values shown in FIG. 3 for XC): P_{Chiplet} Ø(P_{4K} ␣P_{XC})

When limited to address bits within a 2M memory page address space (i.e., only bits a21 to a31), a second coloring function has 3 bits in total (i.e., bits a21, a22, a23), which supports 8 colors: P_{Chiplet} Ø(P_{2M} ␣P_{XC}).

Two more example coloring functions are now described for memory allocation when processor allocation is made at a core granularity, P_{c}orₑ (i.e., assigning the core 111 to a first virtual machine, assigning the core 112 to a second virtual machine). In these examples, the L3 cache slice 115 and the cross-chiplet directory 132 may need to be partitioned to provide suitable isolation, for example by partitioning cache lines across trust domains. In some examples, hardware within the processor 100 may be configured to partition the cache lines. As a first option, the L3 cache is partitioned using Cache Allocation Technology (CAT) and coloring is used to independently partition the cross-chiplet directory 132. For CAT, Class-of-Service (CoS) masks may be used to partition the L3 cache at the way level. For set-associative structures, each way comprises one cache line per cache set, for a total number of N cache lines per way, where N is the number of cache sets. As an example, four Class-of-Services (CoS) may be defined that partition the 16 ways of the L3 cache (i.e., for a 16 way set associative L3 cache), scheduling each of the four cores of chiplets that are split between trust domains: two CoS that include half of the ways for scheduling the cores across two equal-sized trust domains; one CoS that includes three quarters of the ways for scheduling three cores that are allocated to a trust domain; and one CoS that includes all 16 ways for scheduling the cores of chiplets that are allocated to a single trust domain. For coloring, the partition Pxc is used, providing two variants of the contracts:
P_{Core} Ø(P_{4K} ␣P_{XC}) supports 4K pages and 1024 colors, and
P_{Core} Ø(P_{2M} ␣P_{XC}) supports 2M pages but only 8 colors.

An advantage of this first option is that cores and physical memory may be scheduled independently of one another. In other examples, more colors may be used by removing the constraint that L3 is not partitioned, but this would decrease performance when assigning a whole chiplet to a trust domains.

As a second option, both the L3 cache slice 115 and the cross-chiplet directory are jointly partitioned, but without partitioning the L2 caches (e.g., L2 cache 114). For each chiplet that is partitioned across multiple trust domains, its memory partition class is modified using P_{XL3C} and using the contract P_{Core} Ø(P_{4K} ␣P_{XL3C}).

In some examples, each virtual machine (or trust domain) is exclusively assigned a subset of the colors of the memory partition during creation, and exclusively assigned a compute partition class during initial scheduling. This compute partition class is assigned to the virtual machine for its entire lifetime, not just for a scheduling interval, based on the observation that the host is not over-subscribed. In some scenarios, this approach allows the system software to amortize expensive micro-architectural flushing operations (a handful of milliseconds) over virtual machine lifetimes. The host OS (root virtual machine 232) remains responsible for assigning resources to guest virtual machines 234 and 236, but the hypervisor 220 enforces resource isolation and exclusivity invariants, and refuses to create or schedule a virtual machine that would break the isolation contract.

While system software may zero memory and registers between successive assignments of resources to a virtual machine, comprehensive and efficient micro-architectural flushing requires hardware support. The resource scheduler 224 flushes the cache hierarchy (and as a consequence any entries in the chiplet and cross-chiplet directories) both during the initial assignment of resources to the virtual machine and, eventually, after shutting down or destroying the virtual machine and before recycling its resources. While the hypervisor 220 may utilize cache flushing instructions to flush the cache hierarchy at the chiplet granularity, flushing just a part of the cache hierarchy (required when a chiplet is partitioned across different virtual machines) could utilize instead cache eviction sets to avoid degrading the performance of other virtual machines.

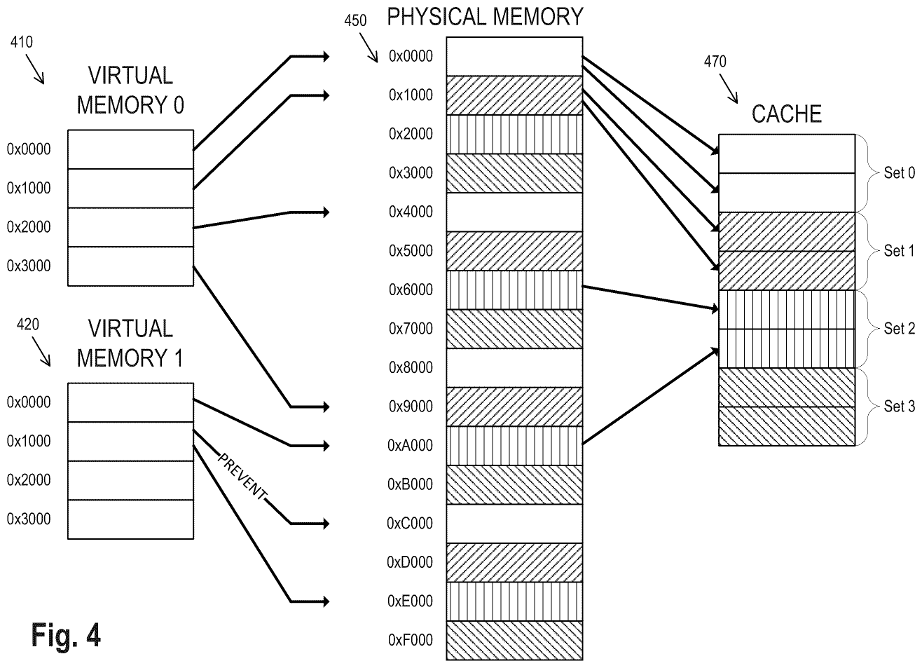

FIG. 4 shows a diagram of an example memory allocation, according to an aspect. A first trust domain 410 and a second trust domain 420 each have their own virtual address space, shown as Virtual Memory 0 for the first trust domain and Virtual Memory 1 for the second trust domain. Physical memory 450 (e.g., corresponding to memory 140) for a processor (not shown) on which the first and second trust domains 410 and 420 are hosted is used for mapping the virtual address spaces. When a memory location in the physical memory 450 is read for the trust domains, the memory location (or a suitable memory block) is read and stored within a cache 470 (e.g., corresponding to the L3 cache slice 115).

In the example shown in FIG. 4, the cache 470 is two-way set associative, providing two available locations within the cache 470 where each memory location from the physical memory 450 may be stored. Locations within the physical memory 450 and the cache 470 are shown with shading according to the available locations and the cache locations are grouped into Set 0, Set 1, Set 2, and Set 3. Accordingly, memory address 0×0000 of the physical memory 450 may be mapped to either a first location or a second location within the Set 0 within the cache 470. Similarly, each of memory addresses 0×4000, 0×8000, and 0×C000 may be mapped to either the first location or the second location within Set 0, each of memory addresses 0×1000, 0×5000, 0×9000, and 0×D000 may be mapped to either the first location or the second location within Set 1, etc.

In some processor architectures, information leakage may occur when memory locations for different trust domains are mapped to the same microarchitectural structures, such as the same cache set, the same directory set, or a same memory bank. Accordingly, when the first trust domain 410 is allocated memory address 0×0000 of the physical memory 450, the second trust domain 420 may be able to perform a side channel attack based on timing delays associated with memory address 0×C000 of the physical memory 450. The memory manager 222 is configured to prevent an allocation of the memory address 0×C000 of the physical memory 450 to the second trust domain 420 using the memory coloring scheme described above. In one example, the memory colors may coincide with the two-way sets of the cache 470, for example, where Set 0 corresponds to a first color, Set 1, corresponds to a second color, Set 3 corresponds to a third color, etc.

In some examples, when additional cache storage is requested for a trust domain, the memory manager 222 allocates colors that are adjacent to each other in the cache. For example, the first and second colors, which correspond to Set 0 and Set 1 of the cache 470, may be allocated to the first trust domain shown in FIG. 4, while the third color (corresponding to Set 2) may be allocated to the second trust domain. By allocating the first and second colors to the first trust domain, the first trust domain has a contiguous cache, which may improve memory performance. Using this example, a coloring function for the first trust domain 410 maps the first four virtual memory locations (OxOOO, OxIO00, 0×2000, 0×3000) to physical memory locations OxOOO, OxIO00, 0×4000, and 0×5000, respectively.

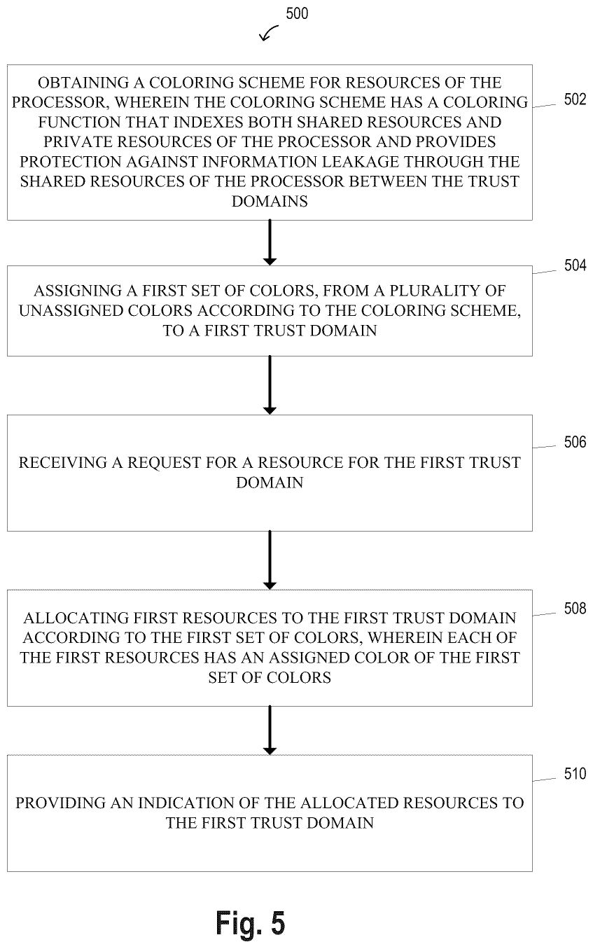

FIG. 5 shows a flowchart of an example method 500 of allocating resources of a processor, according to an aspect. Allocation of the resources may be performed according to a coloring function, for example. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the processor 100 (e.g., via the chiplet 110 running the hypervisor 220), or other suitable computing device.

Method 500 begins with step 502. At step 502, a coloring scheme is obtained for resources of the processor. The coloring scheme has a coloring function that indexes both shared resources and private resources of the processor and provides protection against information leakage through the shared resources of the processor between the trust domains.

In some aspects, obtaining the coloring scheme includes generating a set of coloring functions that each provide protection against information leakage. For example, a set of coloring functions may include a first coloring function for 4K memory pages and a second coloring function for 2M memory pages.

At step 504, a first set of colors are assigned, from a plurality of unassigned colors according to the coloring scheme, to a first trust domain. For example, a first set of memory colors including a color corresponding to Set 2 of the cache 470 is assigned to the trust domain 420. In some examples, the memory manager 222 assigns colors to the trust domain 420 (e.g., a virtual machine) when the trust domain is created and/or initialized on the hardware 210. In one example, the assigned colors remain assigned exclusively to the trust domain for an entire lifetime of the trust domain. The coloring scheme corresponds to a coloring function which may be generated by the memory manager 222, as described herein.

Generally, the coloring scheme uses a number of bits to define a plurality of colors (e.g., 4 colors for 2 bits, 8 colors for 3 bits, 16 colors for 4 bits, etc.). The number of bits may be represented as a bitmap and used as a mask (e.g., a color mask) for restricting available memory addresses. As an example using two bits, four color masks of 00, 01, 10, and 11 may correspond to first, second, third, and fourth colors, respectively. Memory addresses that do not contain the assigned color mask at a designated location are restricted from use by the first trust domain. The four colors may be considered free so long as they are not assigned to a trust domain. More specifically, after assigning the first and second colors to a trust domain, only the third and fourth colors are free for a subsequent assignment. The coloring scheme provides that leakage of information is isolated from other trust domains, where the information is about use of the first resources allocated according to the first set of colors is isolated from other trust domains.

At step 506, a request is received for a resource for the first trust domain. For example, a user may submit a request to create the trust domain 420

At step 508, first resources are allocated to the first trust domain according to the first set of colors. Each of the first resources has an assigned color of the first set of colors. For example, the memory location 0×E000 is allocated to the trust domain 420.

Advantageously, allocation of the memory location 0×C000 is prevented by the memory manager 222 (i.e., by having a different color) because this location would be mapped to a location within the cache 470 that does not provide isolation from the trust domain 410.

At step 510, an indication of the allocated resources is provided to the first trust domain. For example, the memory manager 222 may provide an indication of the allocated memory locations, (e.g., a range of allocated addresses), a pointer to a start of the allocated memory locations, etc.

In some aspects, resources of the processor comprise shared resources and private resources. One or more first linear functions are configured to index the private resources by mapping address bits to first sets of resources, while one or more second linear functions are configured to index the shared resources by mapping address bits to second sets of resources. For example, the hypervisor 220 may identify the index function for the L3/L2 cache (L3/L2, FIG. 3) as the first linear function and identify the index function for the cross-chiplet directory (XD, FIG. 3) as the second linear function. The method 500 may further comprise generating a coloring function using the one or more first linear functions and the one or more second linear functions, where the coloring function indexes both the private resources and the shared resources and divides the shared resources to maximize available colors of the coloring scheme and minimize subdivisions of the private resources. In some aspects, the coloring function supports allocation of individual memory pages or individual cache blocks to the first trust domain as the allocated memory locations. For example, the coloring function avoids or reduces the likelihood of allocating only a portion of a memory page, which may result in reduced performance and/or inefficient allocations of memory. As another example, the coloring function may divide a shared cache or cache coherence directory, but prevent subdivision of a private L2 cache.

In some aspects, the first resources comprise one or more of a physical thread, a memory page, a cache line, and a microarchitectural resource. The microarchitectural resource may be the chiplet directory slice 116, the cross-chiplet directory 132, the L1 cache 113, the L2 cache 114, the L3 cache slice 115, or other suitable microarchitectural resource, in various examples.

Generating the coloring function may include iteratively selecting constraints, from one of the one or more first linear functions, that are independent of constraints from one of the one or more second linear functions and generating the coloring function using the iteratively selected constraints. For subsequent iterations, generating the coloring function comprises iteratively selecting constraints, from another one of the one or more first linear functions, that are independent of constraints from the coloring function. In other words, constraints for a first linear function that indexes the L2 cache 114 may be selected in a first iteration, then constraints for a second linear function that indexes the L3 cache slice 115 may be selected in a second iteration.

In some aspects, the first trust domain relates to at least one of a virtual machine, a container, or other suitable software execution environment.

In some aspects, allocating the first resources comprises using a first color bitmap having bits corresponding to colors of the coloring scheme. For example, the first color bitmap may have sixteen bits, with each bit corresponding to a color of the coloring scheme (e.g., 16 bits for 16 colors, 1024 bits for 1024 colors, etc.). Individual bits within the first color bitmap being set to “1” may indicate that the first trust domain has been assigned the corresponding color, for example. In one example, the first color bitmap is exclusive to the first trust domain. In other words, only the first trust domain is permitted to access the first color bitmap. This approach may reduce a likelihood of another trust domain being able to identify which resources (i.e., colors) have been assigned to the first trust domain. In other examples, the first color bitmap is shared among the first trust domain and a second trust domain (or additional second trust domains). For example, the first color bitmap may have 48 bits using three bits per color for sixteen colors to identify which trust domain of seven trust domains has been assigned a particular color. As an example, a first set of 3 bits within the first color bitmap may have a value of “000” to indicate that a first color is unassigned, a second set of 3 bits may have a value of “001” to indicate that a second color is assigned to a first trust domain, a third set of 3 bits may have a value of “110” to indicate that a third color is assigned to a sixth trust domain, etc.

In some aspects, using the first color bitmap comprises iterating over the first color bitmap to allocate memory locations as the first resources so that the allocated memory locations are adjacent to each other in a physical memory. Referring to FIG. 4 as an example, the first color bitmap may have 12 bits using three bits per color for four colors (corresponding to Set 0, Set 1, Set 2, and Set 3) to identify which trust domain of seven trust domains has been assigned a particular color. In FIG. 4, the first trust domain 410 has been assigned Set 0 and Set 1, the second trust domain 420 has been assigned Set 2, and Set 3 has not been assigned, so the first color bitmap may have a value of (001)(001)(010)(000) (with parenthesis inserted for clarity). Without iterating over the first color bitmap, the memory manager 222 may sequentially allocate addresses (of the physical memory 450)0×0000 0×4000, 0×8000, and 0×C000, which are all within the first color (Set 0). However, this approach may result in the allocated addresses being mapped into the same portion of the cache 470 (i.e., within the same Set) and cause unnecessary replacement of the data within the cache 470. The memory manager 222 may be configured to iterate over the first color bitmap to allocate the memory locations to sequentially allocate addresses 0×0000 (from Set 0), 0×1000 (from Set 1), 0×4000 (from Set 0), and 0×5000 (from Set 1). In this way, the allocated memory pages may be mapped into different sets of the cache 470, reducing a likelihood that data within the cache 470 is overwritten by the same trust domain.

In some aspects, assigning the first set of colors comprises assigning the first set of colors according to a maximum memory size assigned to the first trust domain. For example, when the first trust domain is assigned a maximum memory size of 4 MB with each assignable color spanning 2 MB, the memory manager 222 may assign only two colors, even when additional colors are unassigned. This approach reduces a likelihood that colors would be reassigned at a later time to a different trust domain (e.g., when a second trust domain is initialized) where information about the use of the resources to be reassigned may be accessible (or leakable) to the second trust domain.

In some aspects, the first trust domain is a guest virtual machine and the method 500 further comprises assigning a set of memory colors from the coloring scheme to a root virtual machine, and reserving remaining colors from the coloring scheme for guest virtual machines. The root virtual machine may correspond to the root virtual machine 232 for an operating system of the computing device 100, for example. In other words, a subset of memory colors may be assigned to the root virtual machine 232, with remaining colors free to be assigned to guest virtual machines 234 and 236.

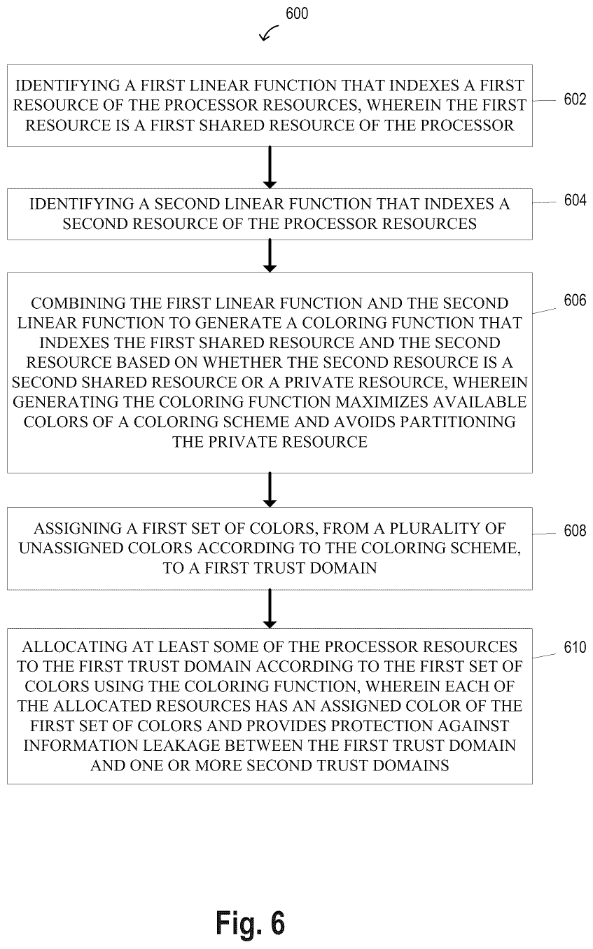

FIG. 6 shows a flowchart of an example method 600 of allocating resources of a processor, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 6. Steps may be performed serially, in a partially overlapping manner, or fully in parallel. Thus, the order in which steps of method 600 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 6 may be performed by the processor 100 (e.g., via the chiplet 110 running the hypervisor 220), or other suitable computing device.

Method 600 begins with step 602. At step 602, a first linear function that indexes a first resource of the processor is identified, where the first resource is a first shared resource of the processor. For example, the hypervisor 220 may identify the index function for the cross-chiplet directory (XD, FIG. 3). In some examples, index functions for the shared resource are provided by a manufacturer of a processor (e.g., the processor 100). In other examples, index functions for the shared resource are reverse engineered.

At step 604, a second linear function that indexes a second resource of the processor is identified. For example, the hypervisor 220 may identify the index function for the L3/L2 cache (L3/L2, FIG. 3). Similarly, index functions for the private resource may be provided by a manufacturer of a processor (e.g., the processor 100), or reverse engineered.

At step 606, the first linear function and the second linear function are combined to generate a coloring function that indexes the first shared resource and the second resource based on whether the second resource is a second shared resource or a private resource. Generating the coloring function maximizes available colors of a coloring scheme for the second shared resource and avoids partitioning the private resource.

At step 608, a first set of colors, from a plurality of unassigned colors according to the coloring scheme, are assigned to a first trust domain.

At step 610, the resources of the processor are allocated to the first trust domain according to the first set of colors using the coloring function, where each of the allocated resources has an assigned color of the first set of colors and provides protection against information leakage between the first trust domain and one or more second trust domains. For example, memory addresses that do not contain an assigned color mask at a designated location within the memory address are restricted from assignment by the memory manager 222 to the corresponding trust domain.

When the second resource is the private resource, step 606 comprises iteratively selecting constraints from the first linear function that are independent of constraints from the second linear function, and generating the coloring function using the selected constraints. In some examples, the constraints are related to the memory partition P_{M}described above, specifically: P_{M} complies with all architectural constraints, e.g. to support page-based allocation: P4_{K} ⊏P_{M}, and ideally P_{2M} ⊏P_{M}; P_{M} partitions all shared microarchitectural resources necessary to achieve isolation; and P_{M} does not partition any private microarchitectural resources (e.g., L2 caches), which would degrade performance. For example, the hypervisor 220 generates the coloring function XC (FIG. 3). In some aspects, the hypervisor 220 uses the coloring function XC without directly generating the coloring function XC, for example, when the coloring function is computed offline or provided by a hardware vendor.

When the second resource is a second shared resource, step 606 comprises: modeling the first linear function as a first matrix and the second linear function as a second matrix; identifying a basis of a kernel for the first matrix and a basis of a kernel for the second matrix; concatenating the basis of the kernel for the first matrix and the basis of the kernel for the second matrix to obtain a concatenated basis; transposing the concatenated basis; and modeling the coloring function as a basis of a kernel of the transposed concatenated basis.

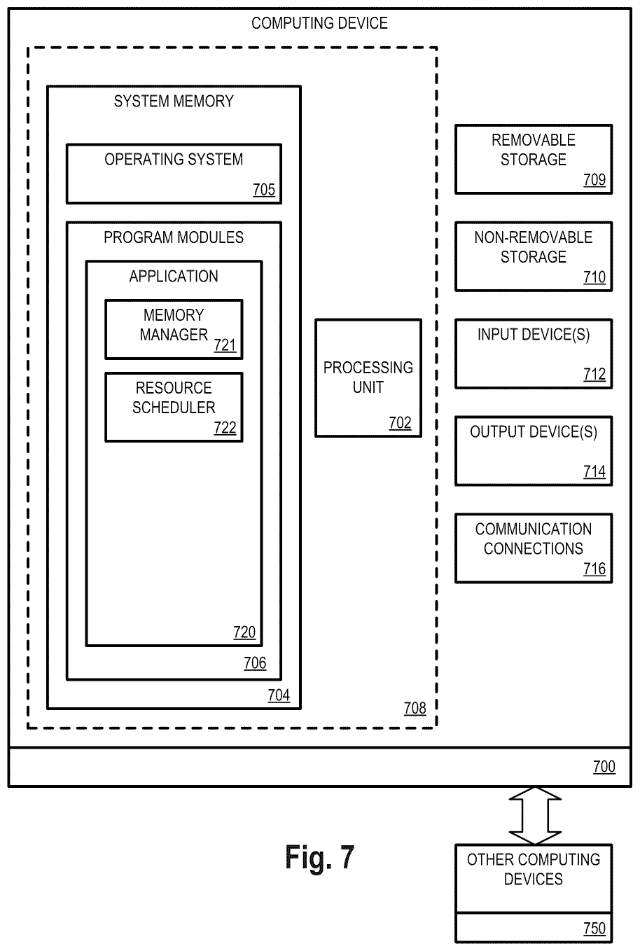

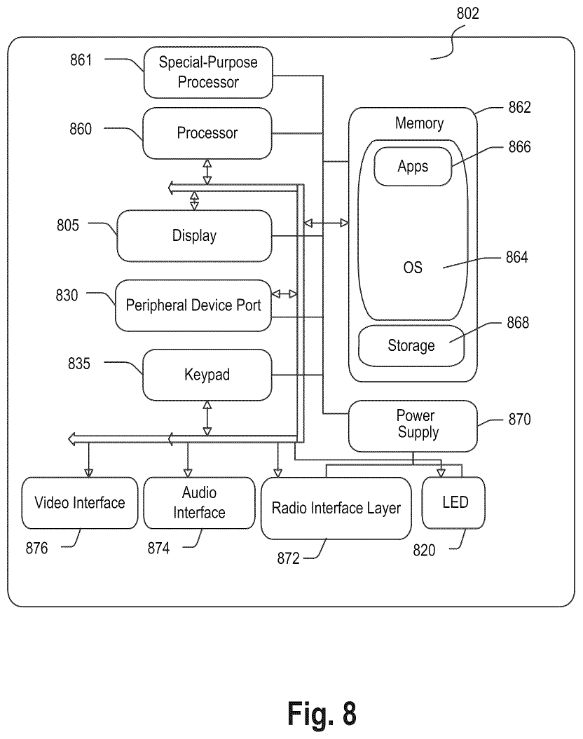

FIGS. 7 and 8 and the associated descriptions provide a discussion of a variety of operating environments in which aspects of the disclosure may be practiced. However, the devices and systems illustrated and discussed with respect to FIGS. 7 and 8 are for purposes of example and illustration and are not limiting of a vast number of computing device configurations that may be utilized for practicing aspects of the disclosure, as described herein.

FIG. 7 is a block diagram illustrating physical components (e.g., hardware) of a computing device 700 with which aspects of the disclosure may be practiced. The computing device components described below may have computer executable instructions for implementing a resource allocation application 720 on a computing device (e.g., processor 100, hypervisor 220), including computer executable instructions for resource allocation application 720 that can be executed to implement the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running resource allocation application 720, such as one or more components with regard to FIGS. 1 and 2 and, in particular, memory manager 721 (e.g., corresponding to memory manager 222) and resource scheduler 722 (e.g., corresponding to resource scheduler 224).

The operating system 705, for example, may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., resource allocation application 720) may perform processes including, but not limited to, the aspects, as described herein. Other program modules that may be used in accordance with aspects of the present disclosure, and in particular for allocating resources, may include processor 100 and hypervisor 220.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 8 illustrates a mobile computing device 800, for example, a mobile telephone, a smart phone, wearable computer (such as a smart watch), a tablet computer, a laptop computer, and the like, with which aspects of the disclosure may be practiced. In some aspects, the client may be a mobile computing device. FIG. 8 is a block diagram illustrating the architecture of one aspect of a mobile computing device. That is, the mobile computing device 800 can incorporate a system (e.g., an architecture) 802 to implement some aspects. In one aspect, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 825 (e.g., audio transducer 825 illustrated in FIG. 8). In the illustrated example, the visual indicator 820 is a light emitting diode (LED) and the audio transducer 825 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 7 and 8 as disclosed herein are described for purposes of illustrating the present methods and systems and are not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for allocating resources of a processor among trust domains, the method comprising:
obtaining a coloring scheme for resources of the processor, wherein the coloring scheme has a coloring function that indexes both shared resources and private resources of the processor and provides protection against information leakage through the shared resources of the processor between the trust domains;
assigning a first set of colors, from a plurality of unassigned colors according to the coloring scheme, to a first trust domain; and
allocating first resources to the first trust domain according to the first set of colors, wherein each of the first resources has an assigned color of the first set of colors.

2. The method of claim 1, wherein:
one or more first indexing functions are configured to index the private resources;
one or more second indexing functions are configured to index the shared resources; and
obtaining the coloring scheme comprises generating the coloring function using the one or more first indexing functions and the one or more second indexing functions, wherein the coloring function indexes both the private resources and the shared resources and divides the shared resources to maximize available colors of the coloring scheme and minimize subdivisions of the private resources.

3. The method of claim 2, wherein the first resources comprise one or more of a physical thread, a memory page, a cache line, and a microarchitectural resource.

4. The method of claim 2, wherein obtaining the coloring scheme further comprises generating a set of coloring functions that each provide protection against information leakage.

5. The method of claim 2, wherein:
the one or more first indexing functions include first linear functions configured to index the private resources by mapping address bits to first sets of resources;
the one or more second indexing functions include second linear functions configured to index the shared resources by mapping address bits to second sets of resources; and
generating the coloring function further comprises iteratively selecting constraints, from one of the first linear functions, that are independent of constraints from one of the second linear functions and generating the coloring function using the iteratively selected constraints.

6. The method of claim 5, wherein generating the coloring function further comprises iteratively selecting constraints, from another one of the first linear functions, that are independent of existing constraints from the coloring function.

7. The method of claim 1, wherein the coloring scheme comprises a set of coloring functions that each index both the shared resources and the private resources of the processor, each of the set of coloring functions having a different number of available colors.

8. The method of claim 1, wherein the first trust domain relates to at least one of a virtual machine or a container.

9. The method of claim 1, wherein allocating the first resources comprises using a first color bitmap having bits corresponding to colors of the coloring scheme.

10. The method of claim 9, wherein the first color bitmap is exclusive to the first trust domain.

11. The method of claim 9, wherein the first color bitmap is shared among the first trust domain and a second trust domain.

12. The method of claim 9, wherein using the first color bitmap comprises iterating over the first color bitmap to allocate memory locations as the first resources so that the allocated memory locations are adjacent to each other in a physical memory.

13. The method of claim 9, wherein assigning the first set of colors comprises assigning the first set of colors according to a maximum memory size assigned to the first trust domain.

14. The method of claim 9, wherein the first trust domain is a guest virtual machine, the method further comprising:
assigning a set of memory colors from the coloring scheme to a root virtual machine; and
reserving remaining colors from the coloring scheme for guest virtual machines.

15. A computing device for allocating processor resources of a processor, the computing device comprising the processor and a non-transitory computer-readable memory, wherein the processor is configured to carry out instructions from the memory that configure the computing device to:
identify a first linear function that indexes a first resource of the processor resources, wherein the first resource is a first shared resource of the processor;
identify a second linear function that indexes a second resource of the processor resources;
combine the first linear function and the second linear function to generate a coloring function that indexes the first shared resource and the second resource based on whether the second resource is a second shared resource or a private resource, wherein generating the coloring function maximizes available colors of a coloring scheme and avoids partitioning the private resource;
assign a first set of colors, from a plurality of unassigned colors according to the coloring scheme, to a first trust domain; and
allocate at least some of the processor resources to the first trust domain according to the first set of colors using the coloring function, wherein each of the allocated resources has an assigned color of the first set of colors and provides protection against information leakage between the first trust domain and one or more second trust domains.

16. The computing device of claim 15, wherein the processor is further configured to carry out instructions from the memory that configure the computing device to:
when the second resource is the second shared resource:
model the first linear function as a first matrix and the second linear function as a second matrix;
identify a basis of a kernel for the first matrix and a basis of a kernel for the second matrix;
concatenate the basis of the kernel for the first matrix and the basis of the kernel for the second matrix to obtain a concatenated basis;
transpose the concatenated basis; and
model the coloring function as a basis of a kernel of the transposed concatenated basis.

17. The computing device of claim 15, wherein the processor is further configured to carry out instructions from the memory that configure the computing device to:
when the second resource is the private resource:
iteratively select constraints from the first linear function that are independent of constraints from the second linear function; and
generate the coloring function using the iteratively selected constraints.

18. A method for allocating processor resources of a processor, the method comprising:
identifying a first linear function that indexes a first resource of the processor resources, wherein the first resource is a first shared resource of the processor;
identifying a second linear function that indexes a second resource of the processor resources;
combining the first linear function and the second linear function to generate a coloring function that indexes the first shared resource and the second resource based on whether the second resource is a second shared resource or a private resource, wherein generating the coloring function maximizes available colors of a coloring scheme and avoids partitioning the private resource;
assigning a first set of colors, from a plurality of unassigned colors according to the coloring scheme, to a first trust domain; and
allocating at least some of the processor resources to the first trust domain according to the first set of colors using the coloring function, wherein each of the allocated resources has an assigned color of the first set of colors and provides protection against information leakage between the first trust domain and one or more second trust domains.

19. The method of claim 18, wherein:
when the second resource is the second shared resource, combining the first linear function and the second linear function to generate the coloring function comprises:
modeling the first linear function as a first matrix and the second linear function as a second matrix;
identifying a basis of a kernel for the first matrix and a basis of a kernel for the second matrix;
concatenating the basis of the kernel for the first matrix and the basis of the kernel for the second matrix to obtain a concatenated basis;
transposing the concatenated basis; and
modeling the coloring function as a basis of a kernel of the transposed concatenated basis.

20. The method of claim 18, wherein:
when the second resource is the private resource, combining the first linear function and the second linear function to generate the coloring function comprises:
iteratively selecting constraints from the first linear function that are independent of constraints from the second linear function; and
generating the coloring function using the iteratively selected constraints.
